(19) United States
(12) Patent Application Publication
(10) Pub. No.: US 2009/0110605 A1
(43) Pub. Date: Apr. 30, 2009

(54) MICROCHEMICAL CHIP AND SAMPLE TREATMENT DEVICE

(75) Inventors: Toshihito KIDO, Matsubara-shi (JP); Shoichi Minato, Sakai-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/207,669

(22) Filed: Sep. 10, 2008

(30) Foreign Application Priority Data
Oct. 30, 2007 (JP) 2007-281747

(51) Int. Cl. B01L 11/00

(52) U.S. Cl. 422/99

(57) ABSTRACT

A microchemical chip includes: a sample loading portion for loading a sample; a driving liquid reservoir holding a driving liquid; a sample channel for communicating at least the driving liquid reservoir, the sample loading portion, an amplifying portion, and a detecting portion with each other; and a pump chamber, formed on the sample channel at a position between the driving liquid reservoir and the sample loading portion, for feeding the driving liquid to transport the sample from the sample loading portion to the amplifying portion.

This application is based on Japanese Patent Application No. 2007-281747 filed on Oct. 30, 2007, the contents of which are hereby incorporated by reference.

### BACKGROUND OF THE INVENTION

1. Field of the Invention

The present invention relates to a microchemical chip, and a sample treatment device.

2. Description of the Related Art

Heretofore, there has been known a microchemical chip for applying a predetermined treatment to a sample such as blood, as disclosed in e.g. Japanese Unexamined Patent Publication No. 2006-121935 (D1). As shown in FIG. 16, a microchemical chip 108 disclosed in D1 includes a pump connecting portion 101 to be connectable to a micropump, a sample loading portion 102 for loading a sample, a reagent reservoir 103 for storing a reagent, a treatment portion for applying a predetermined treatment to the sample, and a waste liquid reservoir 105 for storing a waste liquid. The micropump is equipped in a device body 109 of the sample treatment device. When the microchemical chip 108 is loaded in the device body 109, the micropump is connected to the pump connecting portion 101. Then, in response to driving of the micropump, a driving liquid is fed from the device body 109 to the microchemical chip 108. As the driving liquid is allowed to flow through a channel in the microchemical chip 108, the sample and the reagent are transported to the treatment portion. Thereby, a biochemical reaction required for biochemical analysis such as gene amplification reaction or antigen-antibody reaction is initiated.

Since the conventional microchemical chip has the pump connecting portion to be connected to the micropump, the conventional microchemical chip has a drawback that the driving liquid or the like may be contaminated while being fed through the pump connecting portion.

### SUMMARY OF THE INVENTION

In view of the above, it is an object of the present invention to suppress contamination of a driving liquid or the like.

A microchemical chip according to an aspect of the invention includes a treatment portion for applying a predetermined treatment to a sample to be loaded, wherein a driving liquid for transporting the loaded sample to the treatment portion is held in the microchemical chip.

These and other objects, features and advantages of the present invention will become more apparent upon reading the following detailed description along with the accompanying drawings.

### BRIEF DESCRIPTION OF THE DRAWINGS

FIG. 1 is a block diagram conceptually showing an arrangement of a sample analyzer in a first embodiment of the invention.

FIG. 2 is a diagram conceptually showing an arrangement of a microchemical chip in the first embodiment of the invention.

FIG. 3 is a diagram schematically showing an arrangement of an on-off valve provided in the microchemical chip.

FIG. 4 is a diagram schematically showing an arrangement of a pump chamber provided in the microchemical chip.

FIG. 5 is a characteristic chart conceptually showing a drive voltage of a piezoelectric element.

FIG. 6 is a flowchart showing a DNA amplification process to be performed by the sample analyzer.

FIG. 7 is a flowchart showing a DNA detection process to be performed by the sample analyzer.

FIG. 8 is a diagram conceptually showing an arrangement of a microchemical chip in a second embodiment of the invention.

FIG. 9 is a flowchart showing an extracting process to be performed by a sample treatment device in the second embodiment.

FIG. 10 is a flowchart showing a cleaning process to be performed by the sample treatment device in the second embodiment.

FIG. 11 is a flowchart showing a collecting process to be performed by the sample treatment device in the second embodiment.

FIG. 12 is a diagram schematically showing a modification of the pump chamber.

FIG. 13 is an explanatory diagram for describing a modification of a driving liquid reservoir.

FIG. 14 is an explanatory diagram for describing another modification of the driving liquid reservoir.

FIG. 15 is an explanatory diagram for describing yet another modification of the driving liquid reservoir.

FIG. 16 is a diagram showing a conventional microchemical chip and a device body of a conventional sample treatment device.

### DETAILED DESCRIPTION OF THE PREFERRED EMBODIMENTS OF THE INVENTION

In the following, preferred embodiments of the invention are described referring to the drawings.

### First Embodiment

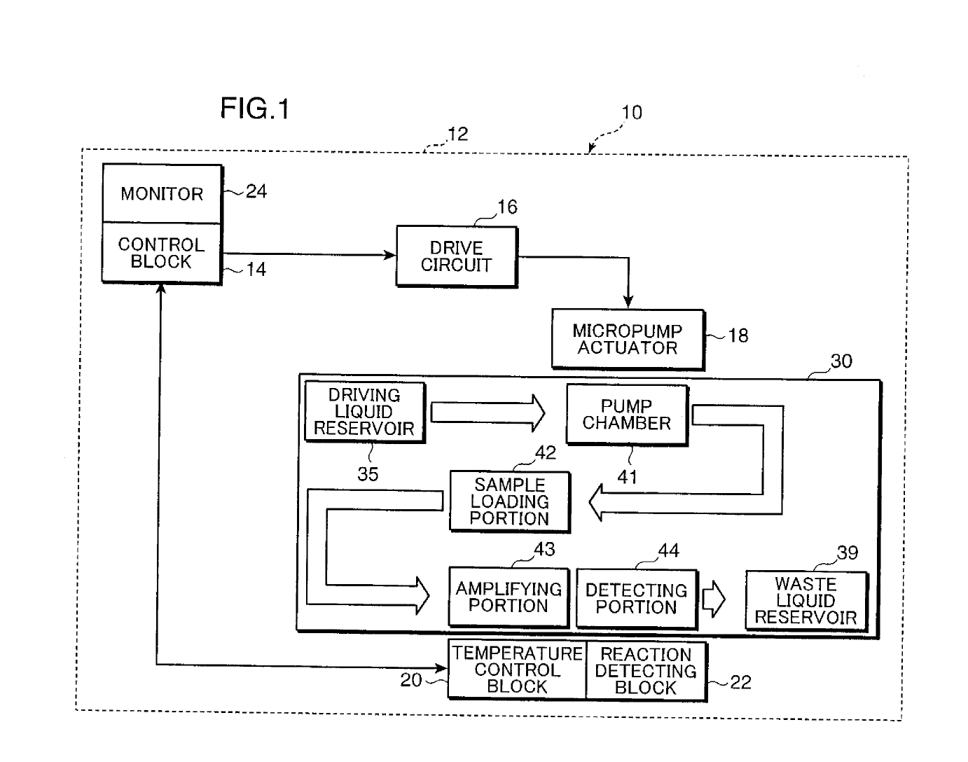

FIG. 1 is a block diagram schematically showing an arrangement of a sample treatment device in accordance with the first embodiment of the invention. The sample treatment device of the first embodiment is a sample analyzer 10 for analyzing DNA extracted from a sample. The sample analyzer 10 includes a microchemical chip 30 and a device body 12.

The device body 12 is constructed in such a manner that the microchemical chip 30 is loadable; and includes a control block 14 as a controller, a drive circuit 16 as a drive controller, a micropump actuator 18 as a pump controller, a temperature control block 20 as a temperature controller, a reaction detecting block 22, and a monitor 24. The control block 14 is a block for integrally controlling the micropump actuator 18, the temperature control block 20, and the reaction detecting block 22; and is operable to display, on the monitor 24, an operation status of the control system, a reaction detection result, and the like.

First, the arrangement of the microchemical chip 30 is described. The microchemical chip 30 is constructed in such a manner as to apply a predetermined treatment to a loaded sample. In the specification, the sample to be loaded is a specimen derived from a living body. Examples of the specimen are whole blood, blood plasma, blood serum, buffy coat, urine, feces, saliva, and sputum. Alternatively, the sample may be a substance obtained by processing or isolating the specimen.

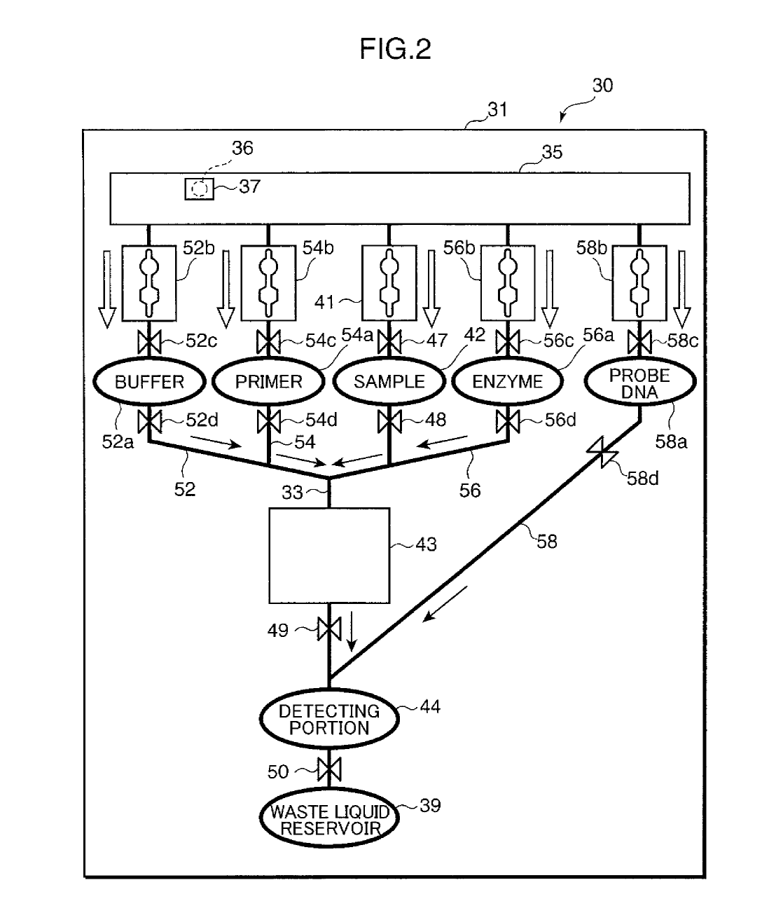

As shown in FIG. 2, the microchemical chip 30 has a chip body 31 made of a transparent resin and having a flat plate-like shape. Producing the chip body 31 of a transparent material enables to perform optical measurement by a detecting portion 44 to be described later. The chip body 31 is produced by attaching two resin plates to each other. Spaces are defined in a proper position between the resin plates to define a sample channel 33, a driving liquid reservoir 35, a pump chamber 41, and a like element, which will be described later.

The sample channel 33 for transporting the sample is defined in the chip body 31. The sample channel 33 is defined in the interior of the chip body 31. The sample channel 33 has an elongated space defined by the paired resin plates constituting the chip body 31. The sample is transported through the elongated space. Specifically, a wall portion constituting the sample channel 33 is formed by a part of the chip body 31.

The driving liquid reservoir 35 is communicated with an upstream end of the sample channel 33. The driving liquid reservoir 35 has a certain space defined by the paired resin plates for holding a driving liquid. Specifically, a wall portion constituting the driving liquid reservoir 35 is formed by a part of the chip body 31. In this embodiment, water is used as the driving liquid. The driving liquid is sealed in the driving liquid reservoir 35 when the microchemical chip 30 is produced.

In this embodiment, the microchemical chip 30 is made disposable. Accordingly, a predetermined amount of the driving liquid required for one treatment of the sample (i.e. performing a series of processing from pre-treatment to analysis) is fluid-tightly held in the driving liquid reservoir 35.

A communication hole 36 is formed in the driving liquid reservoir 35. The inner space of the driving liquid reservoir 35 is communicated with the exterior of the chip body 31 through the communication hole 36. A sealing member 37 such as a seal is releasably attached to the driving liquid reservoir 35 at a position corresponding to the communication hole 36. The communication hole 36 is sealably closed by the sealing member 37. In this arrangement, in the case where the sealing member 37 is releasably attached to the driving liquid reservoir 35 at a position corresponding to the communication hole 36, the inner space of the driving liquid reservoir 35 is blocked from the exterior of the chip body 31. The sealing member 37 is released in use of the microchemical chip 30. The communication hole 36 is defined to allow smooth feeding of the driving liquid.

A waste liquid reservoir 39 is communicated with a downstream end of the sample channel 33. The waste liquid reservoir 39 stores therein a waste liquid such as a sample which has undergone treatment. A wall portion of the waste liquid reservoir 39 is also formed by a part of the chip body 31. Defining the waste liquid reservoir 39 eliminates the need of an operation for discharging the waste liquid to the outside, which is advantageous in discarding the microchemical chip 30 after use without any treatment.

The pump chamber 41, a sample loading portion 42, an amplifying portion 43, and the detecting portion 44 are provided in this order from upstream side along the sample channel 33 between the driving liquid reservoir 35 and the waste liquid reservoir 39. Hereinafter, the sample, the waste liquid, a buffer, a primer, a probe, and the like which are allowed to flow through the chip body 31 are generically called as a fluid according to needs.

The pump chamber 41 is defined to draw out the driving liquid stored in the driving liquid reservoir 35. The sample loading portion 42 is a member constructed in such a manner that the sample is loadable. The sample is loaded from the outside of the chip body 31 through the sample loading portion 42. The amplifying portion 43 is a treatment portion for amplifying the DNA contained in the sample. The amplifying portion 43 is formed at such a position in the chip body 31 that the amplifying portion 43 adjoins the temperature control block 20 of the device body 12, when the microchemical chip 30 is loaded in the device body 12. The detecting portion 44 is a treatment portion for detecting whether a predetermined type of DNA is contained in the DNA extracted from the sample. The detecting portion 44 is formed at such a position in the chip body 31 that the detecting portion 44 adjoins the reaction detecting block 22 of the device body 12, when the microchemical chip 30 is loaded in the device body 12.

Four on-off valves i.e. a first on-off valve 47, a second on-off valve 48, a third on-off valve 49, and a fourth on-off vale 50 are provided in this order from upstream side along the sample channel 33. These on-off valves 47 through 50 are normally in a closed state. The first on-off valve 47 is arranged between the pump chamber 41 and the sample loading portion 42. The second on-off valve 48 is arranged between the sample loading portion 42 and the amplifying portion 43. The third on-off valve 49 is arranged between the amplifying portion 43 and the detecting portion 44. The fourth on-off valve 50 is arranged between the detecting portion 44 and the waste liquid reservoir 39.

Second channels are merged into the sample channel 33. In the microchemical chip 30 of the embodiment, a buffer channel 52, a primer channel 54, an enzyme channel 56, and a probe channel 58 are provided as second channels respectively. Wall portions of the second channel are also formed by a part of the chip body 31.

The buffer channel 52 is a channel including a buffer reservoir 52a for fluid-tightly holding a buffer. A pump chamber 52b, and on-off valves 52c and 52d are provided on the buffer channel 52. The on-off valves 52c and 52d are respectively arranged at upstream side and downstream side of the buffer reservoir 52a. The on-off valves 52c and 52d are normally in a closed state. The pump chamber 52b is arranged between the driving liquid reservoir 35 and the upstream-side on-off valve 52c. In response to actuating the pump chamber 52b, the driving liquid stored in the driving liquid reservoir 35 is allowed to flow into the buffer channel 52.

A downstream end of the buffer channel 52 is communicated with the sample channel 33 at a position between the second on-off valve 48 and the amplifying portion 43. In this arrangement, in response to opening the on-off valves 52c and 52d on the buffer channel 52, the buffer stored in the buffer reservoir 52a is drawn into the amplifying portion 43.

The primer channel 54 is a channel including a primer reservoir 54a for fluid-tightly holding a primer. A pump chamber 54b, and on-off valves 54c and 54d are provided on the primer channel 54. The on-off valves 54c and 54d are respectively arranged at upstream side and downstream side of the primer reservoir 54a. The on-off valves 54c and 54d are normally in a closed state. The pump chamber 54b is arranged between the driving liquid reservoir 35 and the upstream-side on-off valve 54c. In response to actuating the pump chamber 54b, the driving liquid stored in the driving liquid reservoir 35 is allowed to flow into the primer channel 54.

A downstream end of the primer channel 54 is communicated with the sample channel 33 at a position between the second on-off valve 48 and the amplifying portion 43. In this arrangement, in response to opening the on-off valves 54c and 54d on the primer channel 54, the primer stored in the primer reservoir 54a is drawn into the amplifying portion 43.

The enzyme channel 56 is a channel including an enzyme reservoir 56a for fluid-tightly holding an enzyme. A pump chamber 56b, and on-off valves 56c and 56d are provided on the enzyme channel 56. The on-off valves 56c and 56d are respectively arranged at upstream side and downstream side of the enzyme reservoir 56a. The on-off valves 56c and 56d are normally in a closed state. The pump chamber 56b is arranged between the driving liquid reservoir 35 and the upstream-side on-off valve 56c. In response to actuating the pump chamber 56b, the driving liquid stored in the driving liquid reservoir 35 is allowed to flow into the enzyme channel 56.

A downstream end of the enzyme channel 56 is communicated with the sample channel 33 at a position between the second on-off valve 48 and the amplifying portion 43. In this arrangement, in response to opening the on-off valves 56c and 56d on the enzyme channel 56, the enzyme stored in the enzyme reservoir 56a is drawn into the amplifying portion 43.

The probe channel 58 is a channel including a probe reservoir 58a for fluid-tightly holding a probe (i.e. a fluorescent pigment). A pump chamber 58b, and on-off valves 58c and 58d are provided on the probe channel 58. The on-off valves 58c and 58d are respectively arranged at upstream side and downstream side of the probe reservoir 58a. The on-off valves 58c and 58d are normally in a closed state. The pump chamber 58b is arranged between the driving liquid reservoir 35 and the upstream-side on-off valve 58c. In response to actuating the pump chamber 58b, the driving liquid stored in the driving liquid reservoir 35 is allowed to flow into the probe channel 58.

A downstream end of the probe channel 58 is communicated with the sample channel 33 at a position between the third on-off valve 49 and the detecting portion 44. In this arrangement, in response to opening the on-off valves 58c and 58d on the probe channel 58, the probe stored in the probe reservoir 58a is drawn into the detecting portion 44.

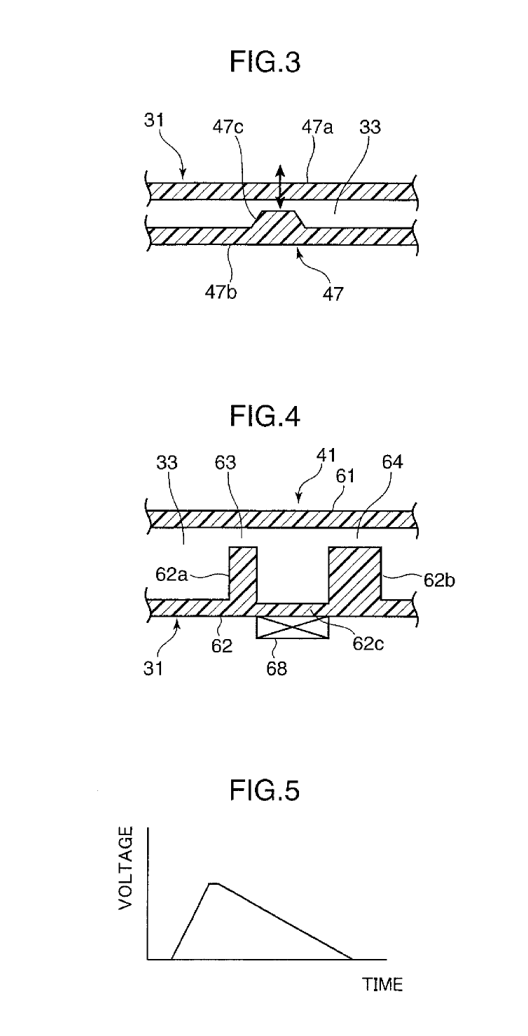

Since all the aforementioned on-off valves have substantially identical arrangements, the arrangement of the first on-off valve 47 is described as a representative of the arrangement of the on-off valves in the following. As shown in FIG. 3, for instance, the first on-off valve 47 is operable to open and close the sample channel 33 by resiliently deforming a wall portion 47a of the first on-off valve 47. A projection 47c projecting toward the inside of the sample channel 33 is formed on the other wall portion 47b of the first on-off valve 47. In this arrangement, slightly deflecting the wall portion 47a inwardly enables to close the sample channel 33. Since the wall portion 47a is made of a resin material constituting the chip body 31, the wall portion 47a is easily subjected to resilient deformation. The first on-off valve 47 is opened and closed, in other words, the wall portion 47a is resiliently deformed by applying an external force from the device body 12. The arrangement of the on-off valve is not limited to the above, but various well-known arrangements may be applicable.

Since all the aforementioned pump chambers have substantially identical arrangements, the arrangement of the pump chamber 41 is described as a representative of the arrangement of the pump chambers in the following. As shown in FIG. 4, the pump chamber 41 is a chamber defined by paired wall portions 61 and 62 constituting a part of the chip body 31, wherein the wall portion 62 includes an upstream wall portion 62a and a downstream wall portion 62b. An orifice defined by the upstream wall portion 62a and a counterpart portion of the wall portion 61 constitutes an inlet port 63 of the pump chamber 41. An orifice defined by the downstream wall portion 62b and a counterpart portion of the wall portion 61 constitutes an outlet port 64 of the pump chamber 41.

The upstream wall portion 62a and the downstream wall portion 62b are different from each other in the size (i.e. a channel length) of a flow direction of the fluid. Specifically, the channel length of the outlet port 64 is longer than the cross sectional size (i.e. a vertical size in FIG. 4) of the orifice of the outlet port 64. Accordingly, a laminar flow is dominant at the outlet port 64, and even if a pressure difference is generated between a front end and a rear end of the outlet port 64 in the fluid flow direction, a variation in flow resistance is small. On the other hand, the channel length of the inlet port 63 is shorter than the cross-sectional size of the orifice of the inlet port 63. Accordingly, as a pressure difference between a front end and a rear end of the inlet port 63 in the fluid flow direction is increased, a turbulent flow is easily generated, and as a result, a variation in flow resistance is increased. It should be noted that the flow resistance at the inlet port 63 is smaller than the flow resistance at the outlet port 64 in a region where the pressure difference is small.

The wall portion 62 has a resiliently deformable portion 62c between the upstream wall portion 62a and the downstream wall portion 62b. When the deformable portion 62c is subjected to resilient deformation, the volume of the pump chamber 41 is increased or decreased, thereby actuating the pump chamber 41.

In the following, constituent elements of the device body 12 are described.

The drive circuit 16 is a driver for controllably driving the micropump actuator 18. The drive circuit 16 controllably drives the micropump actuator 18 based on a command signal from the control block 14.

The micropump actuator 18 is an actuator for operating the pump chamber 41, 52b, 54b, 56b, 58b on the microchemical chip 30. The micropump actuator 18 has a piezoelectric element 68 (see FIG. 4), as an example of an oscillator. Specifically, the piezoelectric element 68 is incorporated in the device body 12. The piezoelectric element 68 is incorporated in each of the pump chambers 41, 52b, 54b, 56b, and 58b. The piezoelectric elements 68 are arranged at such a position as to be operable to press the deformable portions 62c of the pump chambers 41, 52b, 54b, 56b, and 58b on the microchemical chip 30 when the microchemical chip 30 is loaded in the device body 12. The micropump actuators 18 individually control the piezoelectric elements 68, and the deformable portions 62c of the pump chambers 41, 52b, 54b, 56b, and 58b are subjected to resilient deformation upon receiving an external force by the respective corresponding piezoelectric elements 68.

As shown in FIG. 5, the micropump actuator 18 controls the corresponding piezoelectric element 68 with a voltage having a waveform characteristic comprised of a sharp rise and a moderate fall. In this embodiment, the operation of the pump chamber is described by way of the example of the pump chamber 41 provided on the sample channel 33. In the case where the deformable portion 62c is deformed in such a direction as to reduce the volume of the pump chamber 41 i.e. deflect the deformable portion 62c inwardly, a voltage with a sharp rise is applied to the piezoelectric element 68 to sharply deform the deformable portion 62c. In this case, since a pressure difference between the interior and the exterior of the pump chamber 41 is increased, a turbulent flow is generated at the inlet port 63, and a channel resistance at the inlet port 63 is increased. As a result, the feed amount of the driving liquid from the pump chamber 41 is increased at the outlet port 64, as compared with the inlet port 63. Subsequently, in the case where the deformable portion 62c is deformed in such a direction as to increase the volume of the pump chamber 41 i.e. deflect the deformable portion 62c outwardly, a voltage with a moderate fall is applied to the piezoelectric element 68 to moderately deform the deformable portion 62c. In this case, since a pressure difference between the interior and exterior of the pump chamber 41 is reduced, a laminar flow is generated at the inlet port 63 as well as the outlet port 64. As a result, a channel resistance is relatively decreased at the inlet port 63, as compared with the outlet port 64. Thereby, the feed amount of the driving liquid into the pump chamber 41 is increased at the inlet port 63, as compared with the outlet portion 64. By alternately repeating the aforementioned deformations, the driving liquid is allowed to be fed downstream as a whole. The feed amount of the driving liquid per unit time is determined based on the voltage to be applied to the piezoelectric element 68. Thus, the feed amount of the driving liquid can be controlled by controlling the voltage change.

The temperature control block 20 is a block for performing temperature measurement, and heating/cooling with respect to the elements of the microchemical chip 30 in need of temperature control, such as the amplifying portion 43 and the detecting portion 44.

The reaction detecting block 22 is configured in such a manner that excited light emitted from a light source is irradiated onto the detecting portion 44 to measure a fluorescent intensity of light detected on the detecting portion 44 by a detecting circuit (not shown).

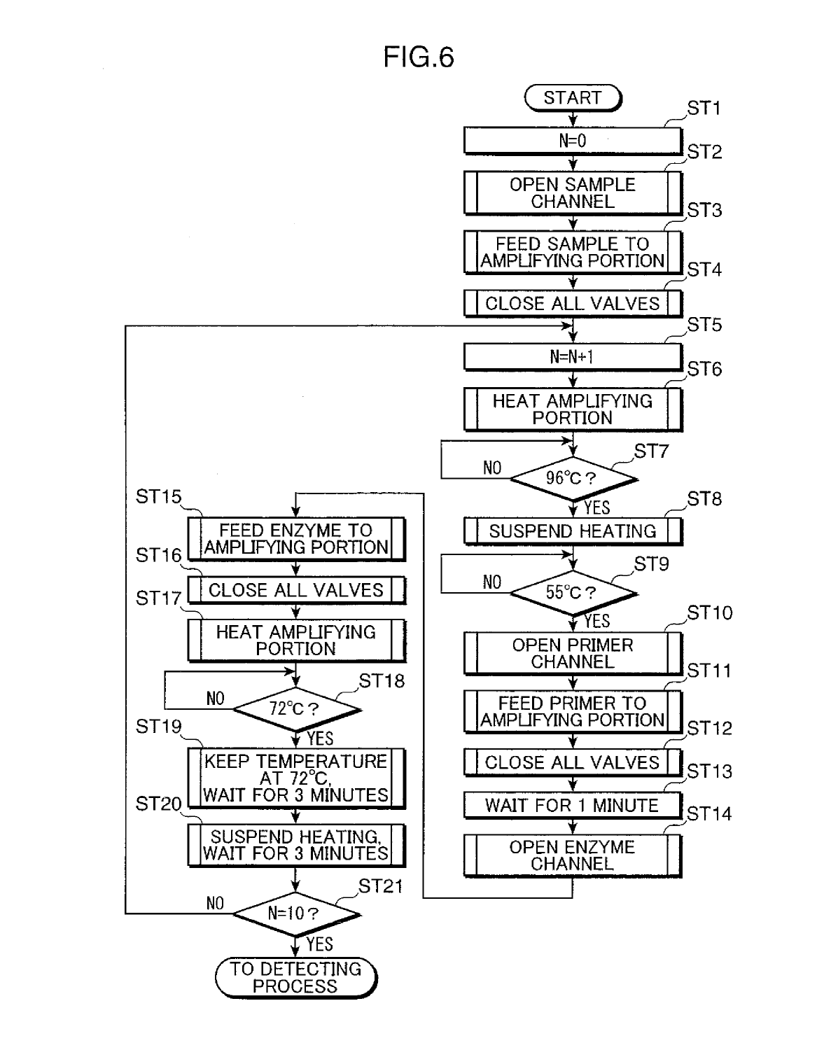

A process for amplifying the DNA contained in a sample, to be performed by the sample analyzer 10 having the above arrangement, is described referring to FIG. 6.

First, the count N is reset (Step ST1), and the first through the fourth on-off valves 47 through 49 on the sample channel 33 are opened (Step ST2). At this time, the on-off valves 52c, 52d, 54c, 54d, 56c, 56d, 58c, and 58d on the second channel merging into the sample channel 33 are kept in a closed state. In response to a command signal from the control block 14, the micropump actuator 18 drives the corresponding piezoelectric element 68 to actuate the pump chamber 41 on the sample channel 33. Thereby, the driving liquid stored in the driving liquid reservoir 35 is fed to the sample channel 33, and the sample loaded in the sample loading portion 42 is transported to the amplifying portion 43 along with the driving liquid (Step ST3). When the sample is transported to the amplifying portion 43, the first through the fourth on-off valves 47 through 49 are closed (Step ST4).

Then, the count N is incremented by 1 (Step ST5), and the amplifying portion 43 is heated to 96° C. by the temperature control block 20 (Step ST6). Then, it is judged whether the temperature of the amplifying portion 43 has reached 96° C. (Step ST7). If it is judged that the temperature of the amplifying portion 43 has reached 96° C. (YES in Step ST7), the heating is suspended (Step ST8). Thereby, the double stranded DNA is rendered single stranded. Subsequently, it is judged whether the temperature of the amplifying portion 43 has lowered to 55° C. (Step ST9). If the temperature of the amplifying portion 43 has lowered to 55° C. (YES in Step ST9), the on-off valves 54c and 54d on the primer channel 54 are opened, and the third on-off valve 49 and the fourth on-off valve 50 on the sample channel 33 are opened (Step ST10). At this time, all the other on-off valves are kept in a closed state. Then, the pump chamber 54b on the primer channel 54 is actuated to draw out the primer stored in the primer reservoir 54a along with the driving liquid stored in the driving liquid reservoir 35 (Step ST11). Then, upon feeding of the primer to the amplifying portion 43, the actuation of the pump chamber 54b is suspended, and all the on-off valves are brought to a closed state (Step ST12). The routine waits in this state for one minute (Step ST13). Thereby, the primer is bound to a complimentary strand of DNA, and RNA is synthesized on the DNA. In other words, a start point and an end point of DNA replication are defined.

Subsequently, the on-off valves 56c and 56d on the enzyme channel 56 are opened, and the third on-off valve 49 and the fourth on-off valve 50 on the sample channel 33 are opened (Step ST14). At this time, all the other on-off valves are kept in a closed state. Then, the pump chamber 56b on the enzyme channel 56 is actuated to draw out the enzyme stored in the enzyme reservoir 56a along with the driving liquid stored in the driving liquid reservoir 35 (Step ST15). Then, upon completion of feeding of the enzyme to the amplifying portion 43, the actuation of the pump chamber 56b is suspended, and all the on-off valves are brought to a closed state (Step ST16). Then, the amplifying portion 43 is heated to 72° C. in this state (Step ST17), and it is judged whether the temperature of the amplifying portion 43 has reached 72° C. (Step ST18). If it is judged that the temperature of the amplifying portion 43 has reached 72° C. (YES in Step ST18), the routine waits in this state for 3 minutes while keeping the temperature of the amplifying portion 43 at 72° C. (Step ST19). Thereafter, the heating is suspended, and the routine waits in this state for three minutes (Step ST20). Thereby, a double stranded DNA is synthesized i.e. copied.

Subsequently, it is judged whether the count N has reached 10 (Step ST21). The operations from Step ST5 through ST 21 are repeated ten times until it is judged that the count N has reached 10 (YES in Step ST21). Thereby, a specific DNA is amplified by the amplifying portion 43.

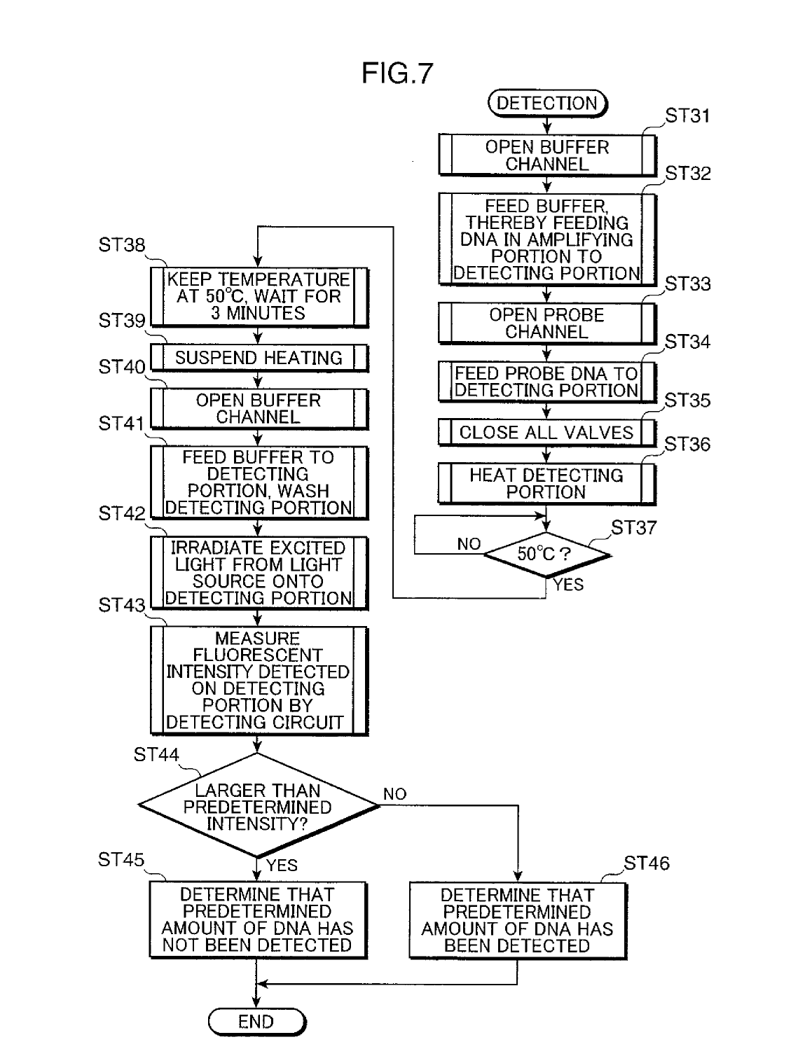

In the following, a DNA detection process to be performed by the sample analyzer 10 is described referring to FIG. 7.

First, the on-off valves 52c and 52d on the buffer channel 52 are opened, and the third on-off valve 49 and the fourth on-off valve 50 on the sample channel 33 are opened (Step ST31). At this time, all the other on-off valves are kept in a closed state. Then, the pump chamber 52b on the buffer channel 52 is actuated to draw out the buffer stored in the buffer reservoir 52a along with the driving liquid stored in the driving liquid reservoir 35, whereby the DNA stored in the amplifying portion 43 is fed to the detecting portion 44 (Step ST32).

Subsequently, the on-off valves 52c and 52d on the buffer channel 52 are closed, the third on-off valve 49 is closed, and the on-off valves 58c and 58d on the probe channel 58 are opened (Step ST33). At this time, all the other on-off valves are kept in a closed state. Then, the pump chamber 58b on the probe channel 58 is actuated to draw out the probe DNA (i.e. a fluorescent-labeled DNA) stored in the probe reservoir 58a along with the driving liquid stored in the driving liquid reservoir 35 (Step ST34). Then, upon completion of feeding of the probe DNA to the detecting portion 44, all the on-off valves are closed (Step ST35). Then, after the temperature of the detecting portion 44 is heated to 50° C. by the temperature control block 20 (Step ST36), it is judged whether the temperature of the detecting portion 44 has reached 50° C. (Step ST37). If it is judged that the temperature of the detecting portion 44 has reached 50° C., (YES in Step ST37), the routine waits in this state for three minutes while keeping the temperature of the detecting portion 44 at 50° C. (Step ST38). Thereafter, the heating is suspended (Step ST39). Thereby, the probe DNA is hybridized to the DNA.

Subsequently, the on-off valves 52c and 52d on the buffer channel 52, and the third on-off valve 49 and the fourth on-off valve 50 on the sample channel 33 are opened (Step ST40), and the pump chamber 52b on the buffer channel 52 is actuated to draw out the buffer stored in the buffer reservoir 52a to the detecting portion 44 to wash the detecting portion 44 (Step ST41). At this time, all the other on-off valves are kept in a closed state. Then, excited light is irradiated onto the detecting portion 44 by the reaction detecting block 22 (Step ST42). Then, the fluorescent intensity of light detected on the detecting portion 44 is measured by the detecting circuit (Step S43). Then, it is judged whether the detected fluorescent intensity is larger than a predetermined light intensity (Step S44). If it is judged that the detected fluorescent intensity is larger than the predetermined light intensity (YES in Step ST44), it is determined that a predetermined amount of DNA has not been detected (Step ST45). If, on the other hand, it is judged that the detected fluorescent intensity is not larger than the predetermined light intensity (NO in Step ST44), it is determined that the predetermined amount of DNA has been detected (Step ST46). For instance, a predetermined amount of streptoavidin (i.e. biotin affinity protein) is bound to the detecting portion 44 in advance. Since streptoavidin is specifically bound to biotin, biotin-labeled DNA is trapped by the streptoavidin. Accordingly, in the case where a predetermined amount of DNA is contained in the sample, the fluorescent intensity is changed before and after the biotin-labeling. In view of this, determination as to whether a predetermined amount of DNA is contained in the sample can be made by measuring the fluorescent intensity.

As described above, since a driving liquid is held in the microchemical chip 30 of the embodiment, there is no need of providing a pump connecting portion or the like, on a channel in the microchemical chip 30, for loading the driving liquid. This arrangement eliminates the need of providing a connecting portion for communicating the exterior of the microchemical chip 30 with the sample analyzer 10 on the sample channel 33, the buffer channel 52, the primer channel 54, the enzyme channel 56, and the probe channel 58, which is advantageous in suppressing contamination of the driving liquid. Also, since the pump chamber 41 is arranged on the sample channel 33 at a position between the driving liquid reservoir 35 and the sample loading portion 42, the sample can be transported from the sample loading portion 42 to the amplifying portion 43 along with the driving liquid fluid-tightly held in the chip body 31. Further, since a predetermined amount of the driving liquid required for treating the sample is fluid-tightly held in the chip body 31, an increase in the size of the microchemical chip 30 itself can be prevented.

Also, since the waste liquid reservoir 39 is provided in the microchemical chip 30 of the embodiment, there can be avoided a cumbersome operation in handling a treated sample. Further, since there is no need of treating a waste liquid after the microchemical chip 30 has been used, the arrangement is particularly advantageous in a disposable microchemical chip.

Further, the microchemical chip 30 of the embodiment has the second channels 52, 54, 56, and 58 for holding the fluid to be fed along with the driving liquid stored in the driving liquid reservoir 35. This arrangement allows the fluid to flow through the second channel along with the driving liquid, and join the sample channel 33, whereby a predetermined function is performed. Since the fluid itself is also fluid-tightly held in the individual reservoirs, contamination of the driving liquid can be suppressed.

Further, since the driving liquid reservoir 35 is commonly communicated with the sample channel 33 and the second channel in the microchemical chip 30 of the embodiment, there can be avoided a cumbersome operation of loading the driving liquid.

Further, in the microchemical chip 30 of the embodiment, the communication hole 36 is formed in the driving liquid reservoir 35, and the sealing member 37 for sealably closing the communication hole 36 is releasably attached to the driving liquid reservoir 35 at the position corresponding to the communication hole 36. This arrangement enables to suppress contamination of the driving liquid before use, and smoothly feed the driving liquid in use.

Further, in the microchemical chip 30 of the embodiment, the wall portion of the driving liquid reservoir 35, the wall portion of the pump chamber 41, and the wall portion of the sample channel 33 constitute a part of the chip body 31. This arrangement enables to simultaneously define the driving liquid reservoir 35, the pump chamber 41, and the sample channel 33 in molding the chip body 31.

Further, in the microchemical chip 30 of the embodiment, the driving liquid can be fed by merely applying an external force for resiliently deforming the deformable portion 62c of the wall portion 62 of the pump chamber 41. This enables to avoid a complicated arrangement of the sample channel 33. Thus, the arrangement is particularly advantageous in feeding the driving liquid in a microchemical chip having a fine sample channel.

In the embodiment, since the piezoelectric element 68 for resiliently deforming the deformable portion 62c of the wall portion 62 of the pump chamber 41 is provided in the device body 12, the pump chamber 41 can be actuated in a state that the microchemical chip 30 without a piezoelectric element is loaded in the device body 12. This enables to simplify the construction of the microchemical chip 30.

### Second Embodiment

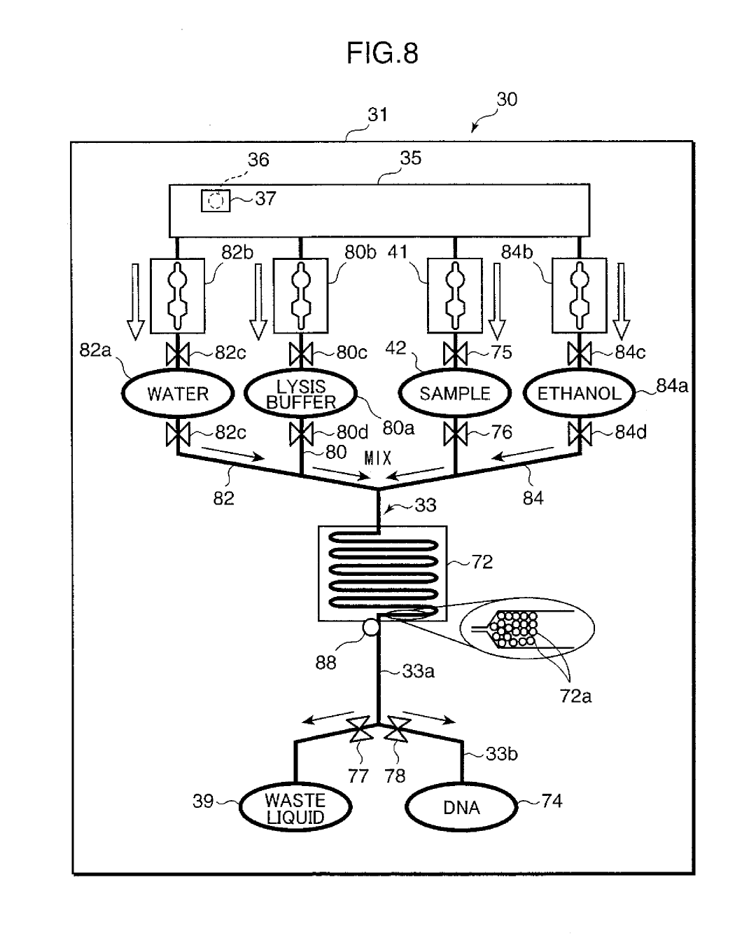

FIG. 8 is a diagram showing the second embodiment of the invention. A microchemical chip 30 in the second embodiment is different from the microchemical chip 30 in the first embodiment in that the microchemical chip 30 in the second embodiment does not have an amplifying portion and a detecting portion. In the following, the second embodiment is described in detail. The elements in the second embodiment substantially identical or equivalent to those in the first embodiment are indicated with the same reference numerals, and detailed description thereof is omitted herein.

A sample treatment device of the second embodiment is constituted as a device for extracting DNA from a sample loaded in the microchemical chip 30. The sample treatment device of the second embodiment does not have a reaction detecting block for analyzing whether a predetermined type of DNA is contained in the sample.

The microchemical chip 30 has a sample channel 33. A driving liquid reservoir 35 is formed at an upstream end of the sample channel 33, and a waste liquid reservoir 39 is formed at a downstream end of the sample channel 33.

A pump chamber 41, a sample loading portion 42, and an extracting portion 72 are formed in this order from upstream side on the sample channel 33. The extracting portion 72 is a treatment portion for extracting DNA contained in the sample. Beads 72a capable of adsorbing the DNA are packed in the extracting portion 72. The extracting portion 72 is capable of releasing the DNA when heated. The heating is performed from the outer periphery of the microchemical chip 30 by a heating portion (not shown) provided in a device body of the sample treatment device.

The sample channel 33 includes a main channel 33a, and a branch channel 33b which is branched out from the main channel 33a at a position between the extracting portion 72 and the waste liquid reservoir 39. A DNA reservoir 74 for storing the DNA extracted from the sample is formed at a downstream end of the branch channel 33b.

Four on-off valves i.e. a first on-off valve 75, a second on-off valve 76, a third on-off valve 77, and a fourth on-off valve 78 are provided on the sample channel 33. The first on-off valve 75, the second on-off valve 76, and the third on-off valve 77 are provided on the main channel 33a, and the fourth on-off valve 78 is provided on the branch channel 33b. The construction of the first on-off valve 75 in the second embodiment is substantially the same as the construction of the first on-off valve 75 in the first embodiment. The second on-off valve 76 is arranged between the sample loading portion 42 and the extracting portion 72, and the third on-off valve 77 is arranged between the extracting portion 72 and the waste liquid reservoir 39.

In this embodiment, a lysis buffer channel 80 and a cleaning liquid channel are provided as a second channel. The lysis buffer channel 80 is a channel including a lysis buffer reservoir 80a for fluid-tightly holding a lysis buffer. A pump chamber 80b, and on-off valves 80c and 80d are provided on the lysis buffer channel 80. The on-off valve 80c and the on-off valve 80d are respectively arranged at upstream side and downstream side of the lysis buffer reservoir 80a. The on-off valves 80c and 80d are normally in a closed state. The pump chamber 80b is arranged between the driving liquid reservoir 35 and the upstream-side on-off valve 80c. In response to actuating the pump chamber 80, the driving liquid stored in the driving liquid reservoir 35 is allowed to flow into the lysis buffer channel 80.

A downstream end of the lysis buffer channel 80 is communicated with the sample channel 33 at a position between the second on-off valve 76 and the extracting portion 72. In this arrangement, in response to opening the on-off valves 80c and 80d on the lysis buffer channel 80, the lysis buffer stored in the lysis buffer reservoir 80a is drawn into the extracting portion 72.

A water channel 82 and an ethanol channel 84 are provided as a cleaning liquid channel. The water channel 82 is a channel including a water reservoir 82a for fluid-tightly holding water. A pump chamber 82b, and on-off valves 82c and 82d are provided on the water channel 82. The on-off valves 82c and 82d are respectively arranged at upstream side and downstream side of the water reservoir 82a. The on-off valves 82c and 82d are normally in a closed state. The pump chamber 82b is arranged between the driving liquid reservoir 35 and the upstream-side on-off valve 82c. In response to actuating the pump chamber 82b, the driving liquid stored in the driving liquid reservoir 35 is allowed to flow into the water channel 82.

A downstream end of the water channel 82 is communicated with the sample channel 33 at a position between the second on-off valve 76 and the extracting portion 72. In this arrangement, in response to opening the on-off valves 82c and 82d on the water channel 82, water stored in the water reservoir 82a is drawn into the extracting portion 72. Similarly to the first embodiment, water is used as the driving liquid in the second embodiment. Accordingly, the water reservoir 82a and the upstream-side on-off valve 82c may be omitted.

The ethanol channel 84 is a channel including an ethanol reservoir 84a for fluid-tightly holding ethanol. A pump chamber 84b, and on-off valves 84c and 84d are provided on the ethanol channel 84. The on-off valves 84c and 84d are respectively arranged at upstream side and downstream side of the ethanol reservoir 84a. The on-off valves 84c and 84d are normally in a closed state. The pump chamber 84b is arranged between the driving liquid reservoir 35 and the upstream-side on-off valve 84c. In response to actuating the pump chamber 84b, the driving liquid stored in the driving liquid reservoir 35 is allowed to flow into the ethanol channel 84.

A downstream end of the ethanol channel 84 is communicated with the sample channel 33 at a position between the second on-off valve 76 and the extracting portion 72. In this arrangement, in response to opening the on-off valves 84c and 84d on the ethanol channel 84, the ethanol stored in the ethanol reservoir 84a is drawn into the extracting portion 72.

A fluid level detecting sensor 88 for detecting whether the sample has reached the extracting portion 72 is provided in the device body. The fluid level detecting sensor 88 is arranged at such a position in the device body that the fluid level detecting sensor 88 is aligned at a position immediately downstream of the extracting portion 72 on the sample channel 33 when the microchemical chip 30 is loaded in the device body.

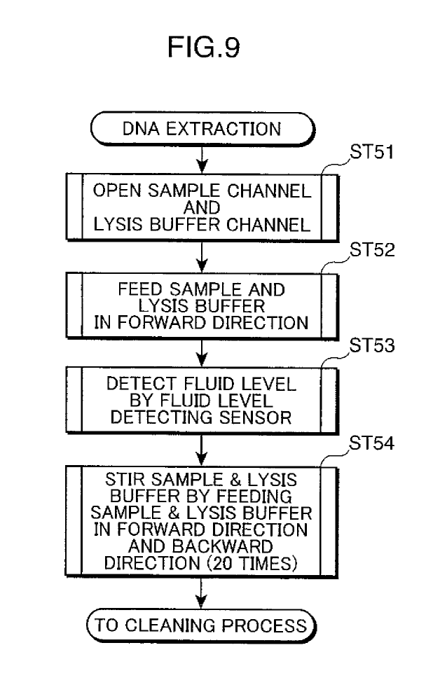

In the following, a DNA extracting operation to be performed by the sample treatment device in the embodiment is described referring to FIGS. 9 through 11. When an DNA extracting process is started, at first, the on-off valves 80c and 80d on the buffer channel 80, and the first, the second, and the third on-off valves 75, 76, and 77 on the sample channel 33 are opened, while the other on-off valves are kept in a closed state (Step ST51). Then, the pump chamber 41 on the sample channel 33, and the pump chamber 80b on the lysis buffer channel 80 are actuated (Step ST52). Thereby, a mixture of the sample and the lysis buffer is allowed to flow into the extracting portion 72.

The mixture as a fluid is fed to the extracting portion 72, while the fluid level thereof is detected by the fluid level detecting sensor 88. When the fluid containing the sample has reached an outlet port of the extracting portion 72, and the fluid level is detected by the fluid level detecting sensor 88 (Step ST53), the fluid feed direction is reversed. The sample and the lysis buffer are stirred by feeding the sample and the lysis buffer in forward direction and backward direction in the fluid feed direction (Step ST54). The back and forth feeding operation is performed e.g. twenty times. Thereby, cell walls of the sample are broken, and the DNA in the sample are adsorbed to the beads 72a.

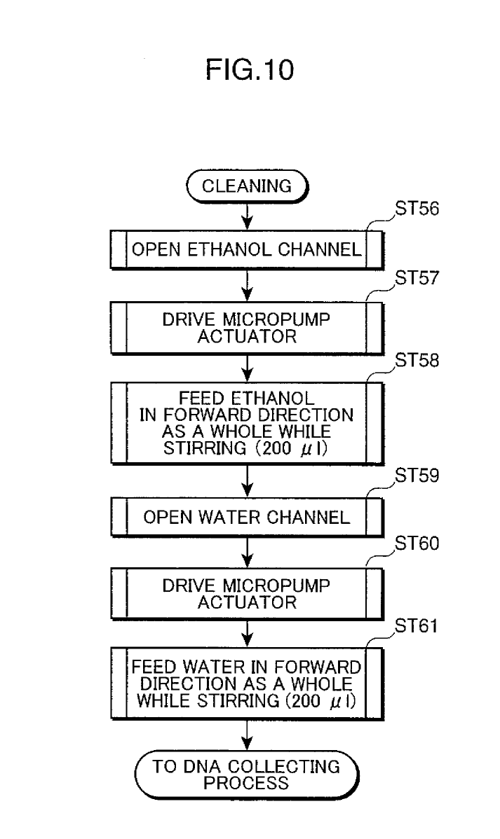

After the DNA extraction is completed, the routine proceeds to a cleaning process. As shown in FIG. 10, when the routine enters the cleaning process, the on-off valves 84c and 84d on the ethanol channel 84, and the third on-off valve 74 on the sample channel 33 are opened, while the other on-off valves are kept in a closed state (Step ST56). Then, a micropump actuator 18 is driven to actuate the pump chamber 84b on the ethanol channel 84 so as to feed the ethanol stored in the ethanol reservoir 84a in the forward direction as a whole (Steps ST57 and ST58). The feed amount of the ethanol is e.g. about 200 μl. Thereby, impurity substances can be washed away, while the DNA is kept being adsorbed to the beads 72a.

Subsequently, the on-off valves 84c and 84d on the ethanol channel 84 are closed, and the on-off valves 82c and 82d on the water channel 82 are opened (Step ST59). At this time, the third on-off vale 77 is kept in an opened state, and the other on-off valves are kept in a closed state. Then, the micropump actuator 18 is driven to actuate the pump chamber 82b on the water channel 82 so as to feed the water stored in the water reservoir 82a in the forward direction as a whole (Steps ST60 and ST61). The feed amount of water is e.g. about 200 μl. After the cleaning process is completed, the routine proceeds to a DNA collecting process.

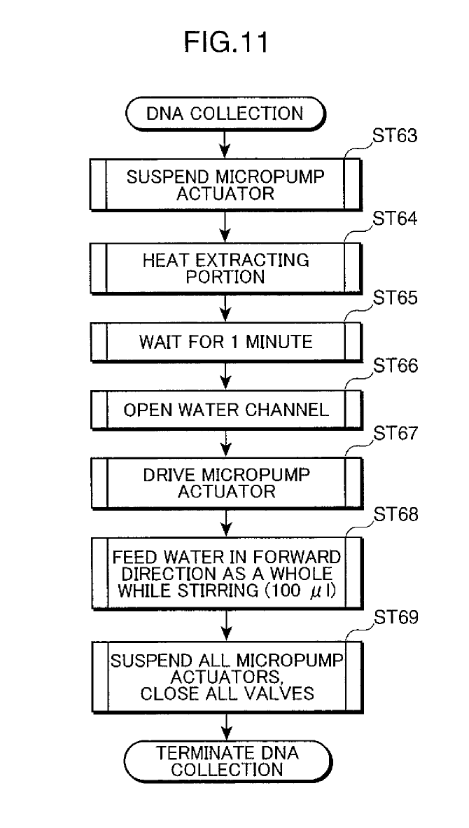

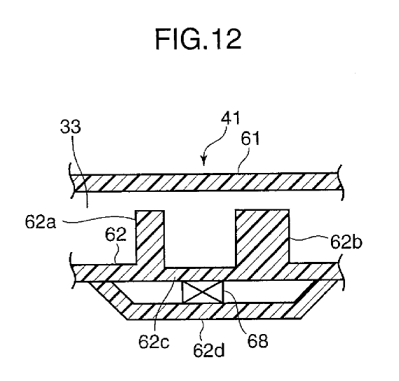

When the routine enters the DNA collecting process, as shown in FIG. 11, the micropump actuator 18 is suspended (Step ST63), the extracting portion 72 is heated (Step ST64), and the routine waits until a predetermined time (e.g. 1 minute) elapses, with the extracting portion 72 being kept in a predetermined temperature range (Step ST65). Thereby, the DNA adsorbed to the beads 72a is released.

Subsequently, the on-off valves 82c and 82d on the water channel 82, and the fourth on-off valve 78 on the sample channel 33 are opened (Step ST66), and the micropump actuator 18 is driven to actuate the pump chamber 82b on the water channel 82 so as to feed the water stored in the water reservoir 82a in the forward direction as a whole (Steps ST67 and ST68). Thereby, the DNA is fed to the DNA reservoir 74 along with the water for storage. Thereafter, the micropump actuator 18 is suspended, and all the on-off valves are closed (Step ST69). Thus, the DNA collecting process is completed.

Similarly to the first embodiment, also in the second embodiment, a driving liquid is held in the microchemical chip 30. Accordingly, there is no need of providing a pump connecting portion or the like, on a channel in the microchemical chip 30, for loading the driving liquid. This eliminates the need of providing a connecting portion for communicating with the exterior of the sample treatment device on the sample channel 33, the lysis buffer channel 80, the water channel 82, and the ethanol channel 84, which is advantageous in suppressing contamination of the driving liquid. Also, since the pump chamber 41 is arranged on the sample channel 33 at a position between the driving liquid reservoir 35 and the sample loading portion 42, the sample can be transported from the sample loading portion 42 to the extracting portion 72 by the driving liquid held in the chip body 31. Further, since a predetermined amount of the driving liquid required for treating the sample is held in the chip body 31, an increase in the size of the microchemical chip 30 itself can be prevented. The other arrangement, operation, and effect of the second embodiment are substantially the same as those of the first embodiment, and accordingly, description thereof is omitted herein.

### Modifications

The present invention is not limited to the foregoing embodiments, but may be modified or revised in various ways as far as such modifications or revisions do not depart from the gist of the invention. For instance, in the first and second embodiments, the oscillator is provided in the device body 12. Alternatively, as shown in FIG. 12, for instance, a piezoelectric element 68 as an oscillator may be provided on a wall portion 62 of a pump chamber 41 in a microchemical chip 30. In the modification, a support portion 62d for holding the piezoelectric element 68 is formed on the wall portion 62 at such a position as to deform a deformable portion 62c by oscillation of the piezoelectric element 68. The modification is advantageous in providing a suitable oscillator in the individual chips.

In the foregoing embodiments, a pump chamber is arranged on each of the channels. Alternatively, for instance, at least a part of the pump chambers may be used in common, and a fluid may be flowed in a channel selected from among the channels communicating with the common-used pump chambers by controlling the on-off valves.

In the foregoing embodiments, the driving liquid reservoir 35 is commonly used by all the channels. Alternatively, the driving liquid reservoir may be commonly used by a part of the channels. Further alternatively, the driving liquid reservoir may be formed individually on the channels.

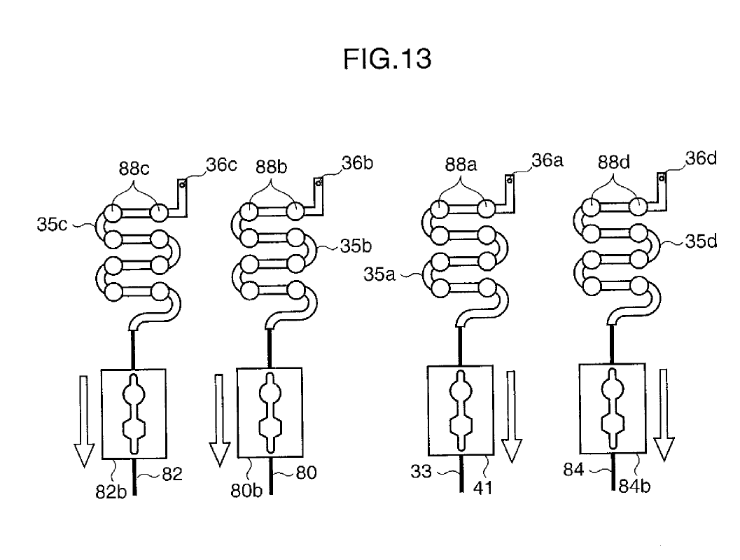

For instance, FIG. 13 shows a modification, wherein driving liquid reservoirs 35a, 35b, 35c, and 35d are formed respectively on a sample channel 33, a lysis buffer channel 80, a water channel 82, and an ethanol channel 84. The driving liquid reservoirs 35a, 35b, 35c, and 35d each has an elongated shape. For instance, the driving liquid reservoir 35a on the sample channel 33 has a volume capable of storing a driving liquid in the amount required for one-time extracting operation Likewise, the driving liquid reservoirs 35b, 35c, and 35d each has a volume capable of storing the driving liquid in the amount required for one-time operation. Air vents 36a, 36b, 36c, and 36d are formed in upstream ends of the driving liquid reservoirs 35a, 35b, 35c, and 35d, respectively. Multiple fluid level detecting sensors 88a, 88b, 88c, 88d are provided in the device body. The air vents 36a through 36d are opened in use. The fluid level detecting sensors 88a through 88d constitute a feed amount detector for detecting a feed amount of the driving liquid. The fluid level detecting sensors 88a, 88b, 88c, 88d are provided at a predetermined position with a predetermined interval in the flow direction of the driving liquid along the driving liquid reservoir 35a, 35b, 35c, 35d; or the sample channel 33, the lysis buffer channel 80, the water channel 82, the ethanol channel 84 (i.e. in the lengthwise direction of the corresponding driving liquid reservoir or the corresponding channel), when the microchemical chip 30 is loaded in the device body. In other words, the fluid level detecting sensors 88a, 88b, 88c, 88d are constructed in such a manner that the volume of the driving liquid reservoir between the adjoining fluid level detecting sensors is set to a predetermined value. When the driving liquid is fed, an interface (i.e. a fluid level) between the driving liquid and the air is sequentially detected by the fluid level detecting sensors 88a, 88b, 88c, 88d from the most upstream fluid level detecting sensor to the downstream in the driving liquid flow direction. This arrangement enables to detect a feed amount of the driving liquid, based on a detection result as to which fluid level detecting sensor of the fluid level detecting sensors 88a, 88b, 88c, 88d has detected the fluid level. In this modification, a predetermined amount of the driving liquid can be fed, which is advantageous in treating the sample without waste of the driving liquid.

Further alternatively, an unillustrated IC tag may be attached to the microchemical chip, and information relating to channel cross section may be memorized in the IC tag. The modification enables to obtain information including a variation in production relating to channel cross section, which is advantageous in accurately calculating a feed amount of the driving liquid. Further alternatively, the above modification may be applied solely to the channel in need of detection of the feed amount of the driving liquid.

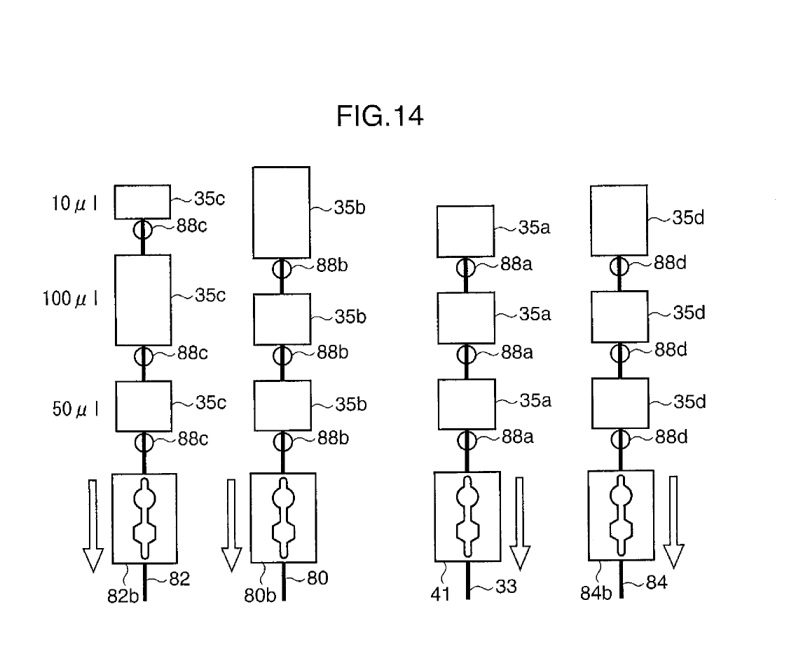

FIG. 14 shows another modification, wherein driving liquid reservoirs are formed individually. In the modification, each of driving liquid reservoirs 35a, 35b, 35c, and 35d has multiple reservoir portions each adapted to store a predetermined amount of a driving liquid required in a corresponding stage of treatment. For instance, in a water channel 82, reservoir portions with a volume of 10 μl, 100 μl, and 50 μl are formed from upstream side in this order in the driving liquid flow direction. In this arrangement, the driving liquid of 10 μl as a required amount in a first stage of treatment is fed by driving a corresponding micropump actuator until a fluid level is detected by a first corresponding fluid level detecting sensor 88c. Then, the driving liquid of 100 μl as a required amount in a second stage of treatment is fed by driving the micropump actuator until a fluid level is detected by a second corresponding fluid level detecting sensor 88c. In FIG. 14, the driving liquid reservoirs 35a, 35b, 35c, and 35d on a sample channel 33, a lysis buffer channel 80, the water channel 82, and an ethanol channel 84 each has three reservoir portions. Alternatively, reservoir portions of the number depending on a stage of treatment may be provided with respect to each of the driving liquid reservoirs 35a, 35b, 35c, and 35d.

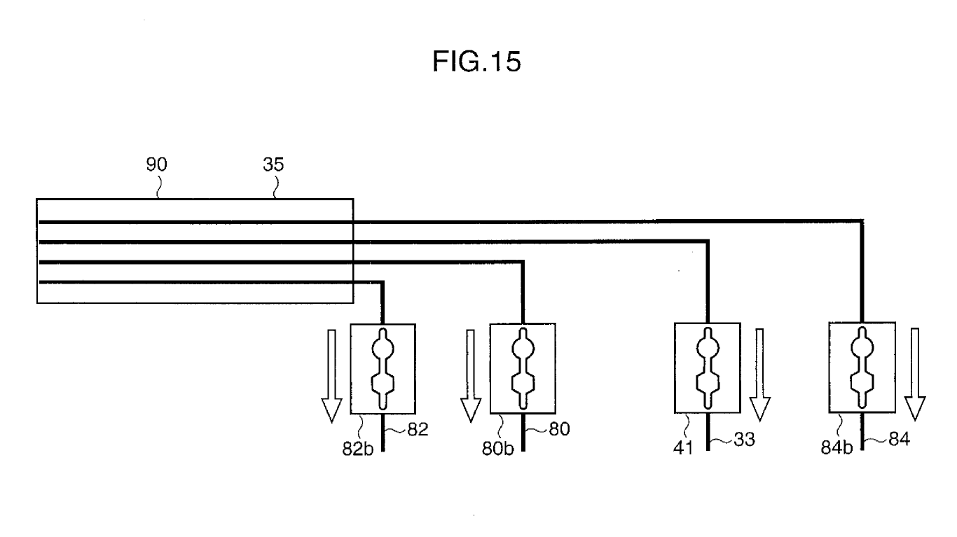

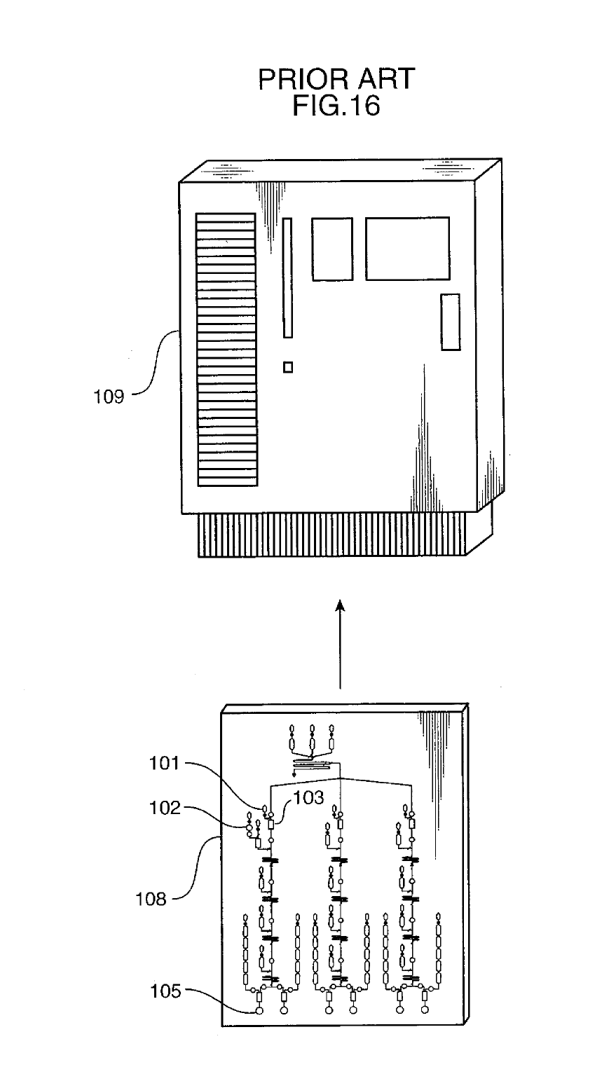

FIG. 15 shows yet another modification for detecting a feed amount of the driving liquid. In the modification, an area sensor 90 is provided in a driving liquid reservoir 35 to directly detect a feed amount of the driving liquid in a sample channel 33, a lysis buffer channel 80, a water channel 82, and an ethanol channel 84.

### Summary of the Embodiments

The following is a summary of the embodiments.

(1) An aspect of the invention is directed to a microchemical chip. Since a driving liquid is held in the microchemical chip, there is no need of providing a pump connecting portion or the like, on a channel in the microchemical chip, for loading the driving liquid. This arrangement eliminates the need of providing a connecting portion, on the channel, for communicating with the exterior of the microchemical chip, which is advantageous in suppressing contamination of the driving liquid. Further, since a predetermined amount of the driving liquid required for treating the sample is held in the microchemical chip, an increase in the size of the microchemical chip itself can be prevented.

(2) Another aspect of the invention is directed to a microchemical chip including: a sample loading portion for loading a sample; a driving liquid reservoir holding a driving liquid; a treatment portion for applying a predetermined treatment to the loaded sample; a sample channel for communicating at least the driving liquid reservoir, the sample loading portion, and the treatment portion with each other; and a pump chamber, formed on the sample channel at a position between the driving liquid reservoir and the sample loading portion, for feeding the driving liquid to transport the sample from the sample loading portion to the treatment portion.

In the above arrangement, since the driving liquid is fluid-tightly held in the driving liquid reservoir in advance, there is no need of providing a pump connecting portion or the like, on the sample channel, for loading the driving liquid. This arrangement eliminates the need of providing a connecting portion, on the sample channel, for communicating with the exterior of the microchemical chip, which is advantageous in suppressing contamination of the driving liquid. Further, since the pump chamber is formed on the sample channel at the position between the driving liquid reservoir and the sample loading portion, the sample can be transported from the sample loading portion to the treatment portion along with the driving liquid held in the microchemical chip. Furthermore, since a predetermined amount of the driving liquid required for treating the sample is held in the microchemical chip, an increase in the size of the microchemical chip itself can be prevented.

(3) Preferably, the microchemical chip may further include a waste liquid reservoir to be communicated with the sample channel. This arrangement enables to avoid a cumbersome operation in handling a treated sample. Further, since there is no need of treating a waste liquid after the microchemical chip has been used, the arrangement is particularly advantageous in a disposable microchemical chip.

(4) Preferably, the microchemical chip may further include a second channel to be communicated with the driving liquid reservoir, the second channel being merged into the sample channel, wherein a fluid to be transported by the driving liquid to be fed from the driving liquid reservoir is held in the second channel. This arrangement_allows the fluid to flow through the second channel along with the driving liquid, and join the sample channel, whereby a predetermined function is performed. Since the fluid itself is also held in the second channel, contamination of the driving liquid can be suppressed.

(5) Preferably, the driving liquid reservoir may be used in common by the sample channel and the second channel. This arrangement enables to avoid a cumbersome operation of loading the driving liquid.

(6) Preferably, the driving liquid reservoir may be individually formed on the sample channel and the second channel. This arrangement enables to individually store a predetermined amount of the driving liquid required in the channels.

(7) Preferably, a communication hole to be communicated with an exterior of the microchemical chip may be formed in the driving liquid reservoir, and a sealing member for sealably closing the communication hole may be releasably attached to the driving liquid reservoir. In this arrangement, the sealing member can be released in use. Accordingly, this arrangement enables to suppress contamination of the driving liquid before use, and smoothly feed the driving liquid in use.

(8) Preferably, the microchemical chip may include a chip body, and a wall portion of the driving liquid reservoir, a wall portion of the pump chamber, and a wall portion of the sample channel may constitute a part of the chip body. This arrangement enables to simultaneously form the driving liquid reservoir, the pump chamber, and the sample channel in molding the chip body.

(9) Preferably, the wall portion of the pump chamber may include a resiliently deformable portion, and the pump chamber may be constructed in such a manner that an inner volume of the pump chamber is changed by deformation of the deformable portion to feed the driving liquid. In this arrangement, the driving liquid in the microchemical chip can be fed by merely applying an external force for resiliently deforming the deformable portion of the wall portion of the pump chamber. This enables to avoid a complicated arrangement of the sample channel. Thus, the arrangement is particularly advantageous in feeding the driving liquid in a microchemical chip having a fine sample channel.

(10) Preferably, the microchemical chip may further include an oscillator for applying an external force to the deformable portion. The oscillator for applying an external force to resiliently deform a part of the wall portion of the pump chamber may not be necessarily provided in the microchemical chip. However, in this arrangement, the oscillator is provided in the microchemical chip. The above arrangement is advantageous in providing a suitable oscillator in the individual chips.

(11) Preferably, the chip body may include a support portion for holding the oscillator to deform the deformable portion. This arrangement enables to efficiently deform the deformable portion.

(12) Yet another aspect of the invention is directed to a sample treatment device including the aforementioned microchemical chip, and a device body for loading the microchemical chip.

(13) In the sample treatment device, preferably, the device body may include a feed amount detector for detecting a feed amount of the driving liquid. This arrangement enables to feed a predetermined amount of the driving liquid, which is advantageous in treating the sample without waste of the driving liquid.

(14) A still another aspect of the invention is directed to a sample treatment device including the aforementioned microchemical chip, and a device body for loading the microchemical chip, wherein the device body includes an oscillator for actuating the pump chamber in the microchemical chip. In this arrangement, the pump chamber can be actuated in a state that the microchemical chip without an oscillator is loaded in the device body. This enables to simplify the arrangement of the microchemical chip.

(15) In the sample treatment device, preferably, the device body may include a feed amount detector for detecting a feed amount of the driving liquid.

(16) Preferably, the feed amount detector may include a plurality of fluid level detecting sensors aligned in a flow direction of the driving liquid to be fed from the driving liquid reservoir in the microchemical chip to be loaded in the device body, and the fluid level detecting sensors each may be operable to detect a fluid level of the driving liquid flowing in the sample channel. In this arrangement, the feed amount of the driving liquid can be detected by detecting the fluid level of the driving liquid by each of the fluid level detecting sensors.

(17) Preferably, the feed amount detector may include an area sensor disposed at a position corresponding to the driving liquid reservoir in the microchemical chip to be loaded in the device body. This arrangement enables to detect the feed amount of the driving liquid in accordance with a detection result of the area sensor.

As described above, since the driving liquid is held in the microchemical chip in the embodiments of the invention, contamination of the driving liquid can be suppressed.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A microchemical chip, comprising:
a treatment portion for applying a predetermined treatment to a sample to be loaded, wherein
a driving liquid for transporting the loaded sample to the treatment portion is held in the microchemical chip.

2. A microchemical chip, comprising:
a sample loading portion for loading a sample;
a driving liquid reservoir holding a driving liquid;
a treatment portion for applying a predetermined treatment to the loaded sample;
a sample channel for communicating at least the driving liquid reservoir, the sample loading portion, and the treatment portion with each other; and
a pump chamber, formed on the sample channel at a position between the driving liquid reservoir and the sample loading portion, for feeding the driving liquid to transport the sample from the sample loading portion to the treatment portion.

3. The microchemical chip according to claim 2, further comprising:
a waste liquid reservoir to be communicated with the sample channel.

4. The microchemical chip according to claim 2, further comprising:
a second channel to be communicated with the driving liquid reservoir, the second channel being merged into the sample channel, wherein
a fluid to be transported by the driving liquid to be fed from the driving liquid reservoir is held in the second channel.

5. The microchemical chip according to claim 4, wherein
the driving liquid reservoir is used in common by the sample channel and the second channel.

6. The microchemical chip according to claim 4, wherein
the driving liquid reservoir is individually formed on the sample channel and the second channel.

7. The microchemical chip according to claim 2, wherein
a communication hole to be communicated with an exterior of the microchemical chip is formed in the driving liquid reservoir, and
a sealing member for sealably closing the communication hole is releasably attached to the driving liquid reservoir.

8. The microchemical chip according to claim 2, wherein
the microchemical chip includes a chip body, and
a wall portion of the driving liquid reservoir, a wall portion of the pump chamber, and a wall portion of the sample channel constitute a part of the chip body.

9. The microchemical chip according to claim 8, wherein
the wall portion of the pump chamber includes a resiliently deformable portion, and
the pump chamber is constructed in such a manner that an inner volume of the pump chamber is changed by deformation of the deformable portion to feed the driving liquid.

10. The microchemical chip according to claim 9, further comprising:
an oscillator for applying an external force to the deformable portion.

11. The microchemical chip according to claim 10, wherein
the chip body includes a support portion for holding the oscillator to deform the deformable portion.

12. A sample treatment device, comprising:
a microchemical chip including
a treatment portion for applying a predetermined treatment to a sample to be loaded, wherein
a driving liquid for transporting the loaded sample to the treatment portion is held in the microchemical chip, and
a device body for loading the microchemical chip.

13. The sample treatment device according to claim 12, wherein
the device body includes a feed amount detector for detecting a feed amount of the driving liquid.

14. A sample treatment device, comprising:
a microchemical chip including
a sample loading portion for loading a sample;
a driving liquid reservoir holding a driving liquid,
a treatment portion for applying a predetermined treatment to the loaded sample,
a sample channel for communicating at least the driving liquid reservoir, the sample loading portion, and the treatment portion with each other, and
a pump chamber, formed on the sample channel at a position between the driving liquid reservoir and the sample loading portion, for feeding the driving liquid to transport the sample from the sample loading portion to the treatment portion; and
a device body for loading the microchemical chip, the device body including an oscillator for actuating the pump chamber in the microchemical chip.

15. The sample treatment device according to claim 14, wherein
the device body includes a feed amount detector for detecting a feed amount of the driving liquid.

16. The sample treatment device according to claim 15, wherein
the feed amount detector includes a plurality of fluid level detecting sensors aligned in a flow direction of the driving liquid to be fed from the driving liquid reservoir in the microchemical chip to be loaded in the device body, and
the fluid level detecting sensors each is operable to detect a fluid level of the driving liquid flowing in the sample channel.

17. The sample treatment device according to claim 15, wherein
the feed amount detector includes an area sensor disposed at a position corresponding to the driving liquid reservoir in the microchemical chip to be loaded in the device body.
